(19) United States
(12) Patent Application Publication
(10) Pub. No.: US 2026/0310156 A1
(43) Pub. Date: Oct. 8, 2026

(54) HYBRID MACHINING PROCESS OPTIMIZATION

(71) Applicant: International Business Machines Corporation, Armonk, NY (US)

(72) Inventors: Neil Delima, Scarborough (CA); Tushar Agrawal, West Fargo, ND (US); Sarbajit Kumar Rakshit, Kolkata (IN); Carolina Garcia Delgado, Zapopan (MX)

(21) Appl. No.: 19/098,097

(22) Filed: Apr. 2, 2025

(51) Int. Cl. G05B 19/18

(52) U.S. Cl. CPC G05B 19/182; G05B 2219/36193

(57) ABSTRACT

Various aspects of the present disclosure generally relate to wireless communication. In some aspects, a computer system may analyze a 3D digital design model of a workpiece to identify geometry for cutting and areas for a surface finish. The system may classify the workpiece into multiple segments for metal cutting, electrochemical machining, or both based on the analysis and historical information of cutting and machining segments of workpieces. The system may determine a sequence of operations between the metal cutting and the electrochemical machining for the multiple segments. The system may determine parameters for the metal cutting and the electrochemical machining to maintain an optimal material thickness for each segment. The system may output instructions for performing the metal cutting and the electrochemical machining on the multiple segments based on the classification of the multiple segments, the sequence of operations, and the parameters.

### BACKGROUND

This disclosure relates to manufacturing and more specifically, to cutting and machining. Various manufacturing processes are utilized to shape and finish workpieces across numerous industries, each process having its own characteristics and applications. These manufacturing processes can be used to create a wide range of workpieces with diverse geometries, materials, and surface properties.

### SUMMARY

Some aspects described herein relate to a method comprising analyzing a three-dimensional (3D) digital design model of a workpiece to identify geometry for cutting and areas for a surface finish. The method comprises classifying the workpiece into multiple segments for metal cutting, electrochemical machining, or both based on the analysis and historical information of cutting and machining segments of workpieces. The method comprises determining a sequence of operations between the metal cutting and the electrochemical machining for the multiple segments. The method comprises determining first parameters for the metal cutting and second parameters for the electrochemical machining to maintain an optimal material thickness for each segment of the multiple segments. The method comprises outputting instructions for performing the metal cutting and the electrochemical machining on the multiple segments based on the classification of the multiple segments, the sequence of operations, the first parameters, and the second parameters.

Some aspects described herein relate to a computer system comprising a processor set, one or more computer-readable storage media, and program instructions stored on the one or more computer-readable storage media to cause the processor set to perform operations. The operations may include analyzing a 3D digital design model of a workpiece to identify areas requiring high surface finish, productivity requirements, heat-sensitive zones, and raw material specifications. The operations may include classifying the workpiece into multiple segments, including segments for metal cutting and segments for electrochemical machining based on the analysis. The operations may include determining a sequence of operations for metal cutting and electrochemical machining of the multiple segments. The operations may include dynamically adjusting metal cutting parameters to maintain an optimal thickness of material for electrochemical machining.

Some aspects described herein relate to a computer program product comprising one or more computer-readable storage media and program instructions stored on the one or more computer-readable storage media to perform operations. The operations may include generating a hybrid cutting-machining plan for a workpiece, including either metal cutting or electrochemical machining for segments of the workpiece, based on a design model analysis of areas of the workpiece requiring a high surface finish or having heat-sensitive zones. The operations may include determining a set of metal cutting parameters for each metal cutting operation in the hybrid cutting-machining plan. The operations may include determining a set of electrochemical machining parameters for each electrochemical machining operation in the hybrid cutting-machining plan. The operations may include integrating the metal cutting operations and the electrochemical machining operations into a manufacturing workflow, wherein the hybrid cutting-machining plan is optimized for optimal surface quality and productivity. The operations may include outputting the manufacturing workflow.

### BRIEF DESCRIPTION OF THE DRAWINGS

FIG. 1 is a diagram of an example computing environment for hybrid machining described herein.

FIG. 2 is a diagram of an example of a workpiece that is to be cut and machined as part of a hybrid machining process.

FIG. 3 is a diagram of an example of segmentation of a workpiece associated with optimizing a hybrid machining process.

FIGS. 4A-4B are diagrams of an example implementation associated with optimizing a hybrid machining process.

FIG. 5 is a flowchart of an example process associated with hybrid machining process optimization.

FIG. 6 is a flowchart of an example process associated with hybrid machining process optimization.

FIG. 7 is a flowchart of an example process associated with hybrid machining process optimization.

### DETAILED DESCRIPTION

The following detailed description of example implementations refers to the accompanying drawings. The same reference numbers in different drawings may identify the same or similar elements.

Manufacturing complex workpieces with varied surface quality requirements poses significant technical challenges. Traditional metal cutting operations can struggle to achieve superior surface finishes, particularly in areas with complex geometries or thermal sensitivity. Furthermore, electrochemical machining, which can produce high-quality surfaces with less tool wear and material stresses, is often limited by its slow material removal rates and high equipment costs.

Current manufacturing approaches frequently rely on manual intervention, requiring skilled operators to identify areas requiring special attention and adjust machining parameters accordingly. This can lead to inconsistent results, reduced productivity, and increased costs. Moreover, the use of multiple machining processes, such as metal cutting and electrochemical machining, can lead to difficulties in optimizing process sequences and parameters to achieve desired surface finishes while minimizing production time and costs.

Some implementations described herein provide a method for optimizing work product manufacturing by integrating hybrid metal cutting and electrochemical machining. For example, a computer system may analyze a 3D digital design model of a workpiece to identify geometry for cutting and areas for a surface finish. The computer system may classify the workpiece into multiple segments for metal cutting, electrochemical machining, or both based on the analysis and historical information for the manufacture of other workpieces. The computer system may determine a sequence of operations between the metal cutting and the electrochemical machining for the multiple segments and determine parameters for the metal cutting and electrochemical machining to maintain an optimal material thickness for each segment. The computer system may output instructions for performing the metal cutting and electrochemical machining on the multiple segments.

In this way, the method provides a hybrid machining system that minimizes processing time and maximizes throughput by optimizing toolpath planning and machining parameter selection. The computer system achieves reduced energy consumption and minimized scrap material generation by ensuring accurate cutting and surface finishing operations. By analyzing the 3D digital design model and utilizing historical information to classify segments for cutting and/or machining, the system determines the optimal sequence and amount of operations and parameters for each segment, thereby reducing computational overhead and conserving system resources. As a result, the computer system conserves processing resources, memory resources, and/or other resources associated with failing to quickly identify optimal machining parameters, recalculating machining parameters in response to suboptimal machining, creating excess scrap material due to machining errors, and/or the like. The computer system achieves reduced network resource utilization by minimizing the need for manual intervention and maximizing the efficiency of machining operations.

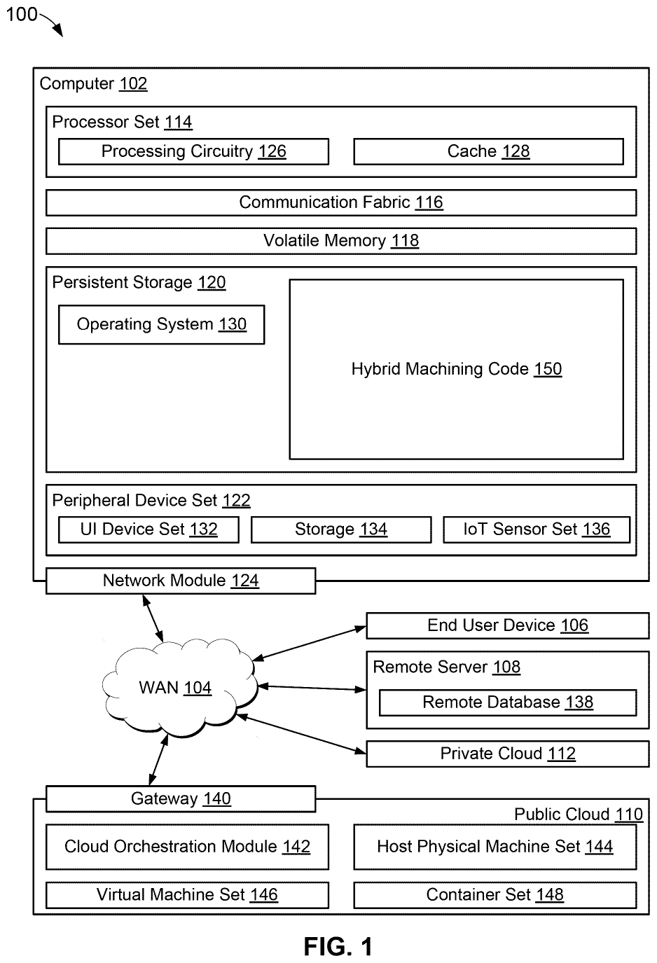

FIG. 1 is a diagram of an example computing environment 100 for hybrid machining described herein.

The computing environment 100 contains an example of an environment for the execution of at least some of the computer code involved in performing the inventive methods, such as hybrid machining code 150. In addition to the hybrid machining code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the hybrid machining code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in hybrid machining code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the hybrid machining code 150 typically includes at least some of the computer code involved in performing one or more operations described herein. The operations may include, for example, analyzing a 3D digital design model of a workpiece to identify geometry for cutting and areas for a surface finish, classifying the workpiece into multiple segments for metal cutting, electrochemical machining, or both based on the analysis and historical information of cutting and machining segments of workpieces. The operations may include determining a sequence of operations between the metal cutting and the electrochemical machining for the multiple segments, determining first parameters for the metal cutting and second parameters for the electrochemical machining to maintain an optimal material thickness for each segment of the multiple segments, and outputting instructions for performing the metal cutting and the electrochemical machining on the multiple segments based on the classification of the multiple segments, the sequence of operations, the first parameters, and the second parameters.

In another example, the operations may comprise analyzing a 3D digital design model of a workpiece to identify areas requiring high surface finish, productivity requirements, heat-sensitive zones, and raw material specifications. The operations may comprise classifying the workpiece into multiple segments, including segments for metal cutting and segments for electrochemical machining based on the analysis. The operations may comprise determining a sequence of operations for metal cutting and electrochemical machining of the multiple segments. The operations may comprise dynamically adjusting metal cutting parameters to maintain an optimal thickness of material for electrochemical machining.

In an example, the operations may comprise generating a hybrid cutting-machining plan for a workpiece, including either metal cutting or electrochemical machining for segments of the workpiece, based on a design model analysis of areas of the workpiece requiring a high surface finish or having heat-sensitive zones. The operations may comprise determining a set of metal cutting parameters for each metal cutting operation in the hybrid cutting-machining plan. The operations may comprise determining a set of electrochemical machining parameters for each electrochemical machining operation in the hybrid cutting-machining plan. The operations may comprise integrating the metal cutting operations and the electrochemical machining operations into a manufacturing workflow, wherein the hybrid cutting-machining plan is optimized for optimal surface quality and productivity. The operations may comprise outputting the manufacturing workflow.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

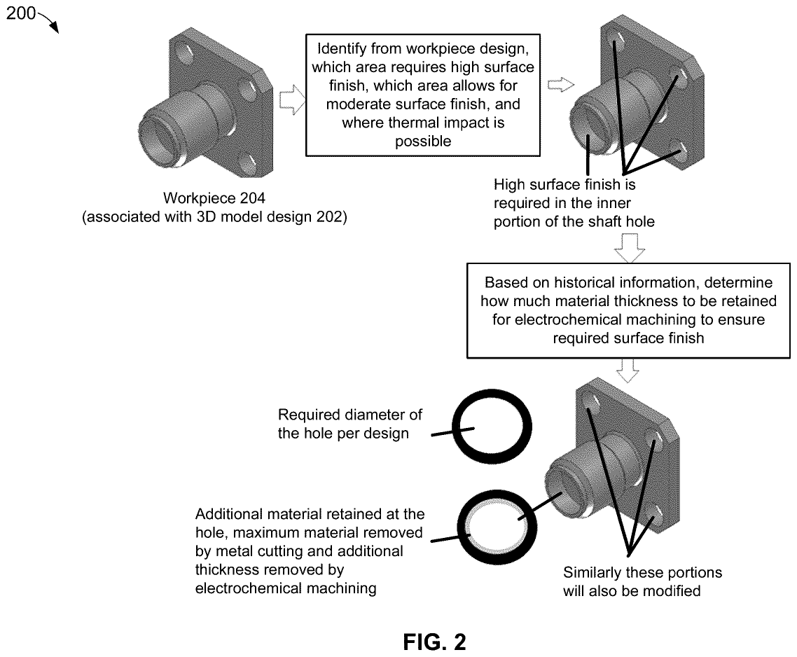

FIG. 2 is a diagram of an example 200 of a workpiece 204 that is to be cut and machined as part of a hybrid machining process. The workpiece 204 may be associated with a 3D model design 202 that indicates specifications for surface finishing, including areas for a high surface finish. The design 202 may also indicate a geometry of the workpiece 204. The geometry may involve shapes and features of the workpiece 204 that are to be cut, such as holes, slots, pockets, edges, faces, and vertices. In example 200, the workpiece 204 has holes, a shaft, and diagonal corners.

The design 202 may be used to identify the areas of the workpiece that require cutting and high surface finishing. In some implementations, the design 202 of the workpiece 204 may be modified in real-time using a generative adversarial network (GAN) to optimize identification of the areas. For example, the GAN may be trained using historical data to learn the optimal surface finish requirements for different types of workpieces. Additionally, or alternatively, a generative machine learning (ML)/artificial intelligence (AI) model may be used to modify the existing design 202 of the workpiece 204. For example, a generative AI model may be trained on historical data to learn the optimal modifications to achieve the desired surface finish. The design 202 may also be used to identify areas of the workpiece 204 that require a moderate surface finish.

The computer system may use the design to select different types of electrochemical machining, such as electrochemical grinding, electrochemical polishing, or electrochemical deburring, depending on the surface finish requirements and geometry of the workpiece. For example, the system may select the type of electrochemical machining based on the material properties and surface finish requirements of the workpiece. Historical information may be used to identify how much material thickness (e.g., the optimal material thickness) to maintain for different types of workpieces and surface finish requirements. The system may further use the design 202 to identify areas of the workpiece 204 that are subject to thermal impact.

The computer system may classify segments of the workpiece 204 into metal-cutting segments or electrochemical machining segments. Classifying segments for metal cutting or electrochemical machining may involve analyzing the 3D digital design model of the workpiece to identify areas that require specific machining operations. The computer system may analyze the geometric features of the workpiece, such as its shape, size, and complexity, to determine which areas require metal cutting, electrochemical machining, or both. For example, areas with complex geometries, such as curved or angled surfaces, may require electrochemical machining to achieve the desired surface finish. Areas with simple geometries, such as flat surfaces, may be suitable for metal cutting. The computer system may analyze the material properties of the workpiece, such as its hardness, conductivity, and reactivity, to determine which areas require metal cutting or electrochemical machining. For example, areas with hard or abrasive materials may require metal cutting with specialized cutting tools. Areas with conductive materials may be suitable for electrochemical machining. The computer system may analyze the machining requirements of the workpiece, such as its surface finish, dimensional accuracy, and production rate, to determine which areas require metal cutting or electrochemical machining. For example, areas requiring a high surface finish may be suitable for electrochemical machining. Areas requiring high dimensional accuracy may require metal cutting with precise cutting tools.

Example 200 shows that the workpiece 204 may have a shaft that is to be cut. The workpiece 204 may have a shaft hole that requires electrochemical machining for a high surface finish. The workpiece 204 may have corners that are to be cut at a diagonal. The workpiece 204 may have holes that are to be both cut and electrochemically machined. The computer system may classify the corresponding segments accordingly.

In some implementations, the computer system may use various techniques, such as machine learning algorithms and clustering models, to classify the workpiece 204 into segments based on the geometric features, material properties, and machining requirements. For example, the computer system may use a clustering model (e.g., k-means clustering) to group similar workpiece segments together based on the geometric features, material properties, and machining requirements. The clustering model may be trained using historical data on machining operations and workpiece properties. For example, the clustering model may group segments with similar geometric features, such as curved surfaces, together and recommend electrochemical machining for those segments. The clustering model may group segments with similar material properties, such as hard materials, together and recommend metal cutting with specialized cutting tools for those segments.

In another example, the computer system may use machine learning algorithms to analyze the 3D digital design model of the workpiece and predict the optimal machining process for each segment. The machine learning algorithms may be trained using historical data on machining operations and workpiece properties. For example, a machine learning algorithm may predict that a particular segment requires electrochemical machining based on its geometric features and material properties. The machine learning algorithm may predict that a particular segment requires metal cutting with specialized cutting tools based on its machining requirements. In some implementations, the computer system may utilize a GAN to modify the 3D design model in real-time to optimize the classification for optimal surface quality and productivity. The computer system may also identify areas on the workpiece suitable for metal cutting and electrochemical machining based on the GAN analysis.

By analyzing the geometric features, material properties, and machining requirements of the workpiece, the system can classify segments for metal cutting or electrochemical machining and optimize the hybrid machining process for each segment.

As indicated above, FIG. 2 is provided as an example. Other examples may differ from what is described with regard to FIG. 2.

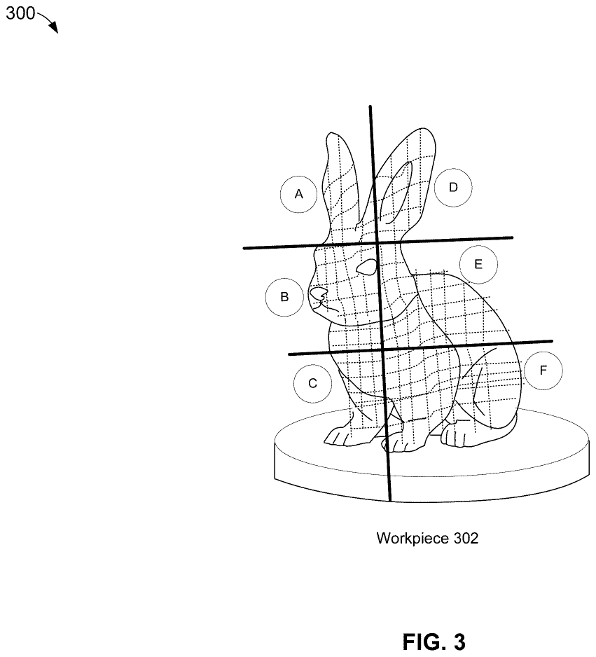

FIG. 3 is a diagram of an example 300 of segmentation of a workpiece associated with optimizing a hybrid machining process. The workpiece 302 in example 300 is a 3D printed rabbit. The design for the workpiece 302 may involve a grid, which is shown for ease of explanation. The workpiece 302 has geometry for cutting and areas for surface finish, with other specifications such as a productivity rate. The design is identified based on a set of parameters based on the geometry of the use case (e.g. complex shape). Different optional parameters may be selected in the analysis.

The computer system may analyze components of the workpiece 302, such as the curvature, deviation, and inner/outer relationships. The computer system may divide the workpiece into geometric clusters labeled A, B, C, D, E, and F. Some clusters are 3D printed while other clusters may have been part of a bending or other shaping operation. Each cluster may include segments, such as the smaller squares of the grid. The computer system may classify the segments in cluster B as electrochemical machining segments. Cluster C may require greater levels of cutting, including additional modification cuts depending on the raw material and the geometry. The computer system may classify some of these segments as metal cutting segments.

The computer system may also identify heat sensitive areas and determine a sequence of operations (between metal-cutting and electrochemical machining) to avoid applying excessive heat to those areas. The computer system may use thermal analysis software to simulate the heat transfer and thermal stress in the workpiece.

The computer system may determine the optimal material thickness for electrochemical machining using historical information (e.g., metal cutting and electrochemical machining history of other printed rabbits of different shapes, or other printed animals). For example, the computer system may analyze data from previous electrochemical machining operations to determine the optimal material thickness for a given workpiece material and geometry. The computer system may use machine learning algorithms to predict the optimal material thickness based on the historical data.

As indicated above, FIG. 3 is provided as an example. Other examples may differ from what is described with regard to FIG. 3.

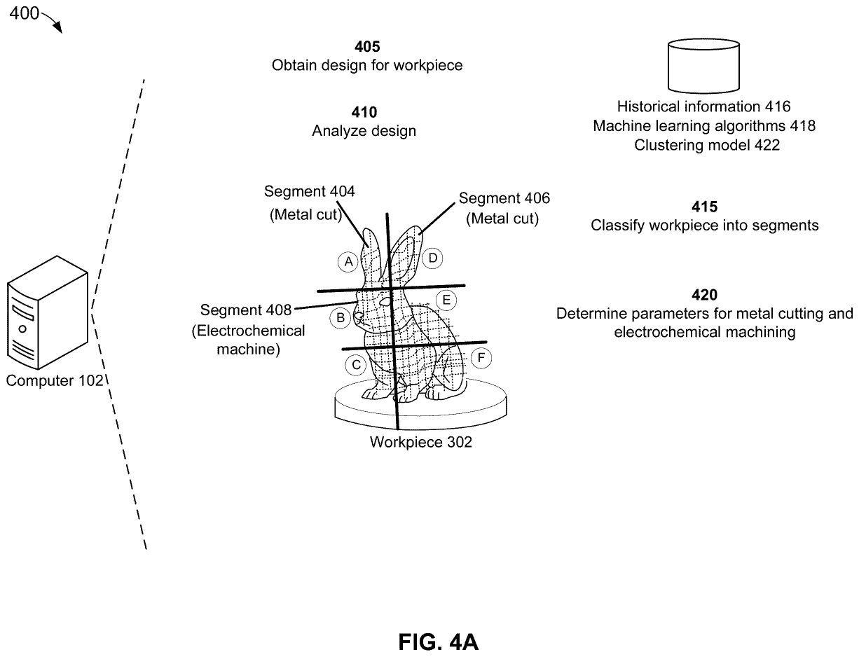

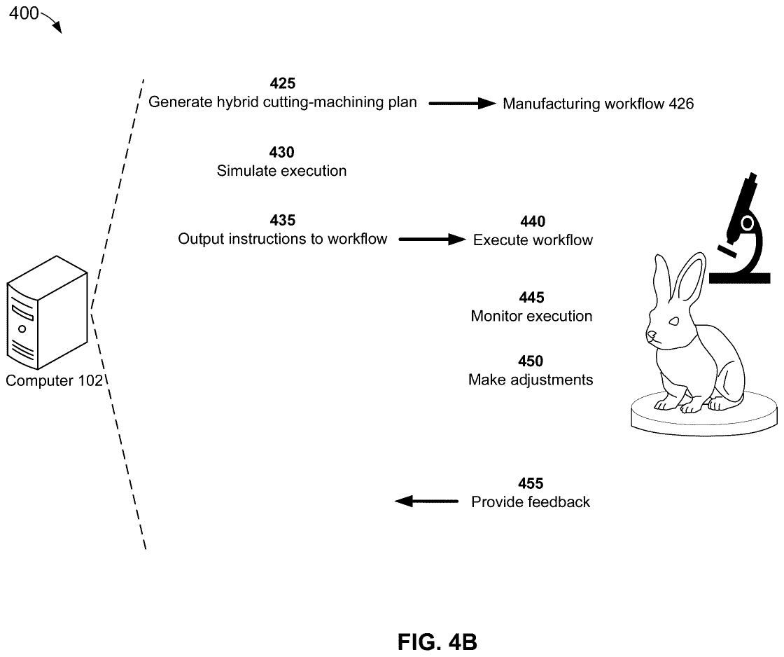

FIGS. 4A-4B are diagrams of an example implementation 400 associated with optimizing a hybrid machining process. As shown in FIG. 4A, the example implementation 400 includes a computer system (e.g., computer 102) that is configured to analyze a design of the workpiece 302. As shown by reference number 405, the computer system may obtain the design (design model) for the workpiece 302. The computer system may analyze the design, as shown by reference number 410. This may include identifying segments from the design, such as segment 404, segment 406, and segment 408, among the other segments. The analysis may also include identifying specifications for shape, thickness, finish, heat sensitivity, and other properties for the segments. The computer system may classify, as part of a hybrid machining plan (hybrid cutting-machining plan), the segments for metal cutting, electrochemical machining, or both based on the analysis. For example, the computer system may classify segment 404 and segment 406 as metal cutting segments and segment 408 as an electrochemical segment. As shown by reference number 415, the computer system may classify the segments using historical information 416 for workpieces, such as properties of segments that have been cut or electrochemically-machined. The properties of historical segments may be compared to properties of the segments of workpiece 302. For example, if a segment of the workpiece 302 has the same or similar properties as a segment of the historical information 416, the classification of the segment of the workpiece 302 may be the same as for the segment of the historical information 416. In some implementations, the computer system may perform the analysis and/or the classification using machine learning algorithms 418 (e.g., GAN) and/or a clustering model 422.

As shown by reference number 420, the computer system may determine parameters for metal-cutting and parameters for electrochemical machining. The parameters may include a type of metal cutting (e.g., milling, turning) required for metal cutting segment. The parameters may include a type of electrochemical machining (e.g., electrochemical grinding or electrochemical polishing).

Metal cutting parameters may also include a cutting speed at which the cutting tool moves through the workpiece. Other metal cutting parameters may include a feed rate (a rate at which the cutting tool advances through the workpiece), a depth of the cut (an amount of material removed in a single pass), tool geometry (shape and size of the cutting tool), and coolant usage (use of cutting fluids to reduce friction, heat, and tool wear). The parameters may be based on the material properties, tool geometry, surface finish requirements, tool life, and machining time.

Electrochemical machining parameters may include electrolyte composition, voltage (between the workpiece 302 and the tool, current density (amount of electric current flowing through the electrolyte solution), tool geometry, and flow rate (rate at which the electrolyte solution flows through the machining area). The parameters may be based on the material removal rate, surface finish, and machining accuracy.

The computer system may use ML algorithms, such as neural networks, to optimize the metal cutting and electrochemical machining parameters. The optimization process involves minimizing or maximizing an objective function that depends on the machining parameters, material properties, and machining requirements. The objective function may include factors such as surface finish (roughness or smoothness of the machined surface), material removal rate (amount of material removed per unit time), tool life, machining time, or energy consumption. By optimizing the metal cutting and electrochemical machining parameters, the computer system can achieve improved surface finish, increased productivity, and reduced energy consumption.

FIG. 4B shows a continuation of the example implementation 400. As shown by reference number 425, the computer system may generate a hybrid cutting-machining plan. For example, the system may integrate the classification data with a manufacturing execution system (MES) or a computer-aided manufacturing (CAM) system to create a workflow 426 that optimizes the machining process. The hybrid cutting-machining plan may include the following workflow components: metal cutting operations (series of metal cutting operations, such as milling, turning, or drilling), electrochemical machining operations (series of electrochemical machining operations, such as electrochemical grinding or electrochemical polishing), transition operations (transition the workpiece between metal cutting and electrochemical machining operations, such as cleaning or deburring), inspection operations (to ensure that the operations meet the desired specifications, such as surface finish or dimensional accuracy), or material handling operations (moving the workpiece between machines or stations, such as robotic handling or conveyor systems).

The computer system may optimize the workflow 426 using ML algorithms to minimize machining time, reduce energy consumption, and improve surface finish. The optimization process may involve adjusting the following parameters: operation sequence, operation parameters (e.g., cutting speed, feed rate, voltage, or current density), transition times, and inspection frequency. By generating a hybrid cutting-machining plan that includes a workflow, the system can optimize the machining process to improve productivity, reduce energy consumption, and improve surface finish.

In some implementations, as shown by reference number 430, the computer system may simulate execution of the workflow 426. Simulating execution of the workflow 426 may involve using computer-aided simulation tools to model the machining process and predict potential errors or defects in the workpiece. The simulation may use a variety of computer-aided simulation tools, such as finite element analysis (FEA) software (uses numerical methods to solve partial differential equations that describe the behavior of physical systems), discrete element method (DEM) software (behavior of particles or objects by solving the equations of motion), computational fluid dynamics (CFD) software (simulates the behavior of fluids and their interactions with surfaces), or ML algorithms. Simulation variables may include workpiece geometry (shape and size of workpiece), machine tool geometry (shape and size of the machine tool), material properties (e.g., density, hardness, or thermal conductivity), machining parameters (e.g., cutting speed, feed rate, or depth of cut), and environmental conditions (e.g., temperature, humidity, or vibrations). Simulation output may include surface finish, dimensional accuracy, material removal rate, tool wear, and error detection. Simulation can increase accuracy and productivity while reducing material waste.

As shown by reference number 435, the computer system may output instructions for performing the metal cutting and the electrochemical machining on the multiple segments based on the classification of the multiple segments, the sequence of operations, the first parameters, and the second parameters. Additionally, or alternatively, the computer system may integrate data of the classification into a manufacturing system to create the workflow 426 and set machining sequences and parameters for metal cutting and electrochemical machining. For example, the computer system may communicate with the manufacturing system to ensure that the workflow 426 is optimized for optimal surface quality and productivity. As shown by reference number 440, the computer system may execute the workflow 426 with the cutting and machining tools.

As shown by reference number 445, the computer system may monitor execution of the workflow 426 in real-time. As shown by reference number 450, the computer system may make adjustments. The computer system may adjust a sequence of metal cutting and electrochemical machining operations, the set of metal cutting parameters, or the set of electrochemical machining parameters based on a surface quality threshold and productivity information.

As shown by reference number 455, the computer system may obtain feedback for the multiple segments and adapt the classification of the multiple segments, the sequence of operations, the first parameters, and the second parameters based on the feedback. For example, the computer system may receive feedback from sensors or operators and adjust the system accordingly.

Additionally, or alternatively, the computer system may obtain input for controlling switching between metal cutting and electrochemical machining. For example, the computer system may receive input from an operator or a sensor to switch between metal cutting and electrochemical machining. To obtain the input, the computer system may generate a graphical user interface that displays the plan and obtains modifications of the plan. For example, the computer system may display a 3D model of the workpiece and allow the user to interactively modify the machining plan, such as by selecting different machining operations or adjusting parameters. The computer system may obtain input for controlling switching between metal cutting and electrochemical machining. For example, the computer system may receive input from an operator or a sensor indicating that a switch from metal cutting to electrochemical machining is required, and adjust the machining process accordingly.

FIGS. 4A-4B are provided as an example. Other examples may differ from what is described with regard to FIGS. 4A-4B.

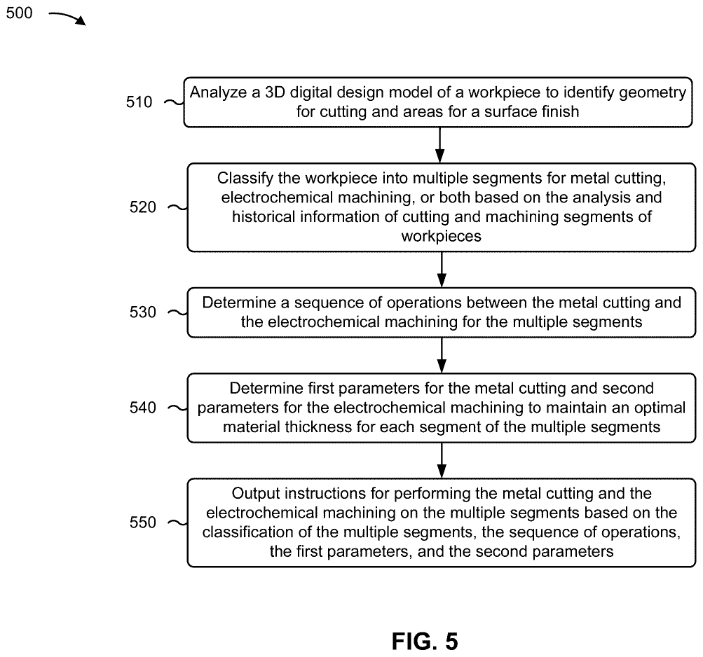

FIG. 5 is a flowchart of an example process 500 associated with hybrid machining process optimization. One or more process blocks of FIG. 5 are performed by a computer system (e.g., computer 102) and/or by another device or a group of devices separate from or including the computer system.

As shown in FIG. 5, process 500 includes analyzing a 3D digital design model of a workpiece to identify geometry for cutting and areas for a surface finish (block 510). For example, the computer system may analyze a 3D digital design model of a workpiece to identify geometry for cutting and areas for a surface finish, as described above.

As further shown in FIG. 5, process 500 includes classifying the workpiece into multiple segments for metal cutting, electrochemical machining, or both based on the analysis and historical information of cutting and machining segments of workpieces (block 520). For example, the computer system may classify the workpiece into multiple segments for metal cutting, electrochemical machining, or both based on the analysis and historical information of cutting and machining segments of workpieces, as described above.

As further shown in FIG. 5, process 500 includes determining a sequence of operations between the metal cutting and the electrochemical machining for the multiple segments (block 530). For example, the computer system may determine a sequence of operations between the metal cutting and the electrochemical machining for the multiple segments, as described above.

As further shown in FIG. 5, process 500 includes determining first parameters for the metal cutting and second parameters for the electrochemical machining to maintain an optimal material thickness for each segment of the multiple segments (block 540). For example, the computer system may determine first parameters for the metal cutting and second parameters for the electrochemical machining to maintain an optimal material thickness for each segment of the multiple segments, as described above.

As further shown in FIG. 5, process 500 includes outputting instructions for performing the metal cutting and the electrochemical machining on the multiple segments based on the classification of the multiple segments, the sequence of operations, the first parameters, and the second parameters (block 550). For example, the computer system may output instructions for performing the metal cutting and the electrochemical machining on the multiple segments based on the classification of the multiple segments, the sequence of operations, the first parameters, and the second parameters, as described above.

Process 500 may include additional aspects, such as any single aspect or any combination of aspects described below and/or in connection with one or more other processes described elsewhere herein.

In a first aspect, process 500 includes utilizing a GAN to modify the 3D design model in real-time to optimize the classifying for optimal surface quality and productivity.

In a second aspect, alone or in combination with the first aspect, process 500 includes identifying areas on the workpiece suitable for metal cutting and electrochemical machining based on the analysis.

In a third aspect, alone or in combination with one or more of the first and second aspects, the classifying the workpiece into segments comprises using a clustering model that is trained using historic workpiece specification data.

In a fourth aspect, alone or in combination with one or more of the first through third aspects, the determining the sequence of operations comprises considering heat sensitivity areas, higher surface finish requirements, and complex shapes of the workpiece.

In a fifth aspect, alone or in combination with one or more of the first through fourth aspects, process 500 includes using the historical information to determine the optimal material thickness for electrochemical machining.

In a sixth aspect, alone or in combination with one or more of the first through fifth aspects, the outputting of the instructions comprises integrating data of the classifying into a manufacturing system to create a workflow and set machining sequences and parameters for metal cutting and electrochemical machining.

In a seventh aspect, alone or in combination with one or more of the first through sixth aspects, process 500 includes obtaining feedback for the multiple segments, and adapting the classification of the multiple segments, the sequence of operations, the first parameters, and the second parameters based on the feedback.

In an eighth aspect, alone or in combination with one or more of the first through seventh aspects, process 500 includes obtaining input for controlling switching between metal cutting and electrochemical machining.

In a ninth aspect, alone or in combination with one or more of the first through eighth aspects, process 500 includes selecting a type of electrochemical machining for a segment of the workpiece.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

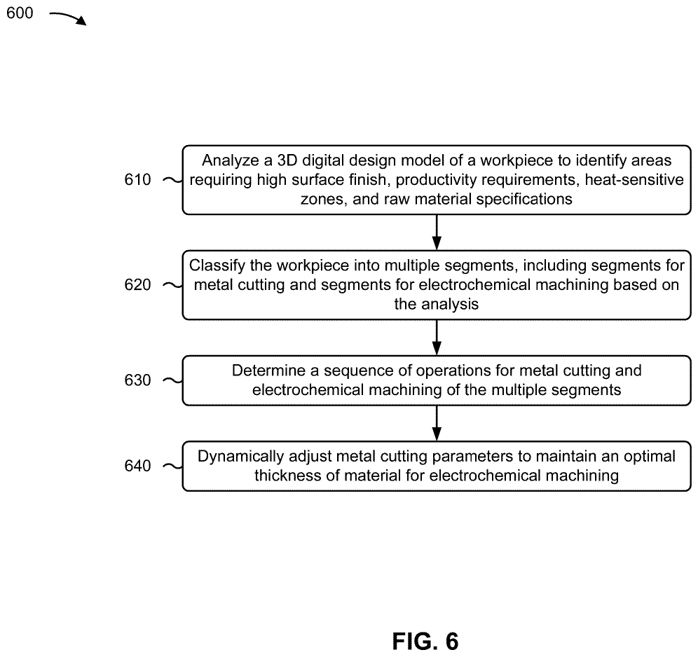

FIG. 6 is a flowchart of an example process 600 associated with hybrid machining process optimization. One or more process blocks of FIG. 6 are performed by a computer system (e.g., computer 102) and/or by another device or a group of devices separate from or including the computer system.

As shown in FIG. 6, process 600 includes analyzing a 3D digital design model of a workpiece to identify areas requiring high surface finish, productivity requirements, heat-sensitive zones, and raw material specifications (block 610). For example, the computer system may analyze a 3D digital design model of a workpiece to identify areas requiring high surface finish, productivity requirements, heat-sensitive zones, and raw material specifications, as described above.

As further shown in FIG. 6, process 600 includes classifying the workpiece into multiple segments, including segments for metal cutting and segments for electrochemical machining based on the analysis (block 620). For example, the computer system may classify the workpiece into multiple segments, including segments for metal cutting and segments for electrochemical machining based on the analysis, as described above.

As further shown in FIG. 6, process 600 includes determining a sequence of operations for metal cutting and electrochemical machining of the multiple segments (block 630). For example, the computer system may determine a sequence of operations for metal cutting and electrochemical machining of the multiple segments, as described above.

As further shown in FIG. 6, process 600 includes dynamically adjusting metal cutting parameters to maintain an optimal thickness of material for electrochemical machining (block 640). For example, the computer system may dynamically adjust metal cutting parameters to maintain an optimal thickness of material for electrochemical machining, as described above.

Process 600 may include additional aspects, such as any single aspect or any combination of aspects described below and/or in connection with one or more other processes described elsewhere herein.

In a first aspect, the operations further comprise utilizing a GAN to modify the classifying for optimal surface quality and productivity.

In a second aspect, alone or in combination with the first aspect, the operations further comprise selecting a type of electrochemical machining required for each segment of the segments for electrochemical machining based on historical information of cutting and machining workpieces.

In a third aspect, alone or in combination with one or more of the first and second aspects, the operations further comprise selecting a type of metal cutting required for each segment of the segments for metal cutting based on historical information of cutting and machining workpieces.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

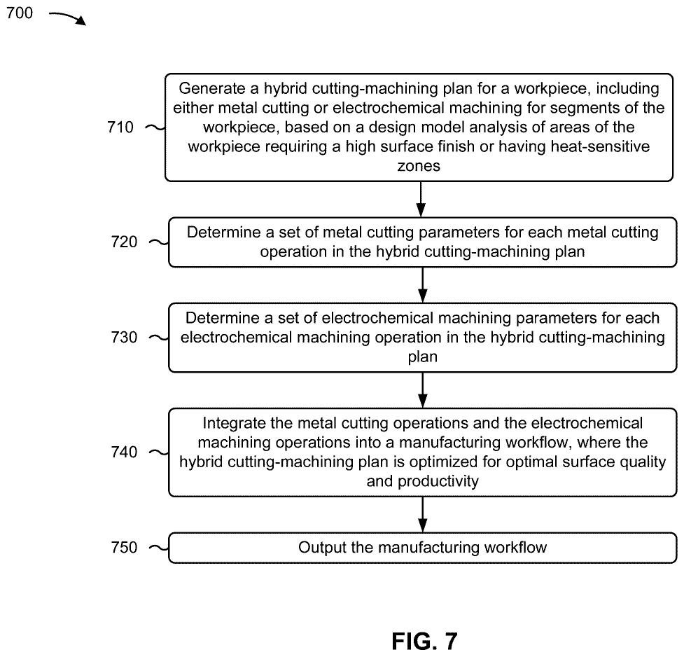

FIG. 7 is a flowchart of an example process 700 associated with hybrid machining process optimization. One or more process blocks of FIG. 7 are performed by a computer system (e.g., computer 102) and/or by another device or a group of devices separate from or including the computer system.

As shown in FIG. 7, process 700 includes generating a hybrid cutting-machining plan for a workpiece, including either metal cutting or electrochemical machining for segments of the workpiece, based on a design model analysis of areas of the workpiece requiring a high surface finish or having heat-sensitive zones (block 710). For example, the computer system may generate a hybrid cutting-machining plan for a workpiece, including either metal cutting or electrochemical machining for segments of the workpiece, based on a design model analysis of areas of the workpiece requiring a high surface finish or having heat-sensitive zones, as described above.

As further shown in FIG. 7, process 700 includes determining a set of metal cutting parameters for each metal cutting operation in the hybrid cutting-machining plan (block 720). For example, the computer system may determine a set of metal cutting parameters for each metal cutting operation in the hybrid cutting-machining plan, as described above.

As further shown in FIG. 7, process 700 includes determining a set of electrochemical machining parameters for each electrochemical machining operation in the hybrid cutting-machining plan (block 730). For example, the computer system may determine a set of electrochemical machining parameters for each electrochemical machining operation in the hybrid cutting-machining plan, as described above.

As further shown in FIG. 7, process 700 includes integrating the metal cutting operations and the electrochemical machining operations into a manufacturing workflow, where the hybrid cutting-machining plan is optimized for optimal surface quality and productivity (block 740). For example, the computer system may integrate the metal cutting operations and the electrochemical machining operations into a manufacturing workflow, where the hybrid cutting-machining plan is optimized for optimal surface quality and productivity, as described above.

As further shown in FIG. 7, process 700 includes outputting the manufacturing workflow (block 750). For example, the computer system may output the manufacturing workflow, as described above.

Process 700 may include additional aspects, such as any single aspect or any combination of aspects described below and/or in connection with one or more other processes described elsewhere herein.

In a first aspect, the operations further comprise generating a graphical user interface that displays the hybrid cutting-machining plan and obtains modifications of the hybrid cutting-machining plan.

In a second aspect, alone or in combination with the first aspect, the operations further comprise selecting a type of cutting and a type of electrochemical machining for each segment of the segments based on the analysis.

In a third aspect, alone or in combination with one or more of the first and second aspects, the operations further comprise monitoring execution of the manufacturing workflow in real-time, and adjusting a sequence of metal cutting and electrochemical machining operations, the set of metal cutting parameters, or the set of electrochemical machining parameters based on a surface quality threshold and productivity information.

In a fourth aspect, alone or in combination with one or more of the first through third aspects, the operations further comprise using historical data and machine learning algorithms to classify each segment of the segments of the workpiece as a metal cutting segment, an electrochemical machining segment, or both a metal cutting and electrochemical machining segment.

In a fifth aspect, alone or in combination with one or more of the first through fourth aspects, the operations further comprise simulating execution of the hybrid cutting-machining plan to predict potential errors or defects in the workpiece.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
analyzing a 3D digital design model of a workpiece to identify geometry for cutting and areas for a surface finish;
classifying the workpiece into multiple segments for metal cutting, electrochemical machining, or both based on the analysis and historical information of cutting and machining segments of workpieces;
determining a sequence of operations between the metal cutting and the electrochemical machining for the multiple segments;
determining first parameters for the metal cutting and second parameters for the electrochemical machining to maintain an optimal material thickness for each segment of the multiple segments; and
outputting instructions for performing the metal cutting and the electrochemical machining on the multiple segments based on the classification of the multiple segments, the sequence of operations, the first parameters, and the second parameters.

2. The method of claim 1, further comprising:
utilizing a generative adversarial network (GAN) to modify the 3D design model in real-time to optimize the classifying for optimal surface quality and productivity.

3. The method of claim 1, further comprising:
identifying areas on the workpiece suitable for metal cutting and electrochemical machining based on the analysis.

4. The method of claim 1, wherein the classifying the workpiece into segments comprises:
using a clustering model that is trained using historic workpiece specification data.

5. The method of claim 1, wherein the determining the sequence of operations comprises:
considering heat sensitivity areas, higher surface finish requirements, and complex shapes of the workpiece.

6. The method of claim 1, further comprising:
using the historical information to determine the optimal material thickness for electrochemical machining.

7. The method of claim 1, wherein the outputting of the instructions comprises:
integrating data of the classifying into a manufacturing system to create a workflow and set machining sequences and parameters for metal cutting and electrochemical machining.

8. The method of claim 1, further comprising:
obtaining feedback for the multiple segments; and
adapting the classification of the multiple segments, the sequence of operations, the first parameters, and the second parameters based on the feedback.

9. The method of claim 1, further comprising:
obtaining input for controlling switching between metal cutting and electrochemical machining.

10. The method of claim 1, further comprising:
selecting a type of electrochemical machining for a segment of the workpiece.

11. A computer system comprising:
a processor set;
one or more computer-readable storage media; and
program instructions stored on the one or more computer-readable storage media to cause the processor set to perform operations comprising:
analyzing a 3D digital design model of a workpiece to identify areas requiring high surface finish, productivity requirements, heat-sensitive zones, and raw material specifications;
classifying the workpiece into multiple segments, including segments for metal cutting and segments for electrochemical machining based on the analysis;
determining a sequence of operations for metal cutting and electrochemical machining of the multiple segments; and
dynamically adjusting metal cutting parameters to maintain an optimal thickness of material for electrochemical machining.

12. The computer system of claim 11, wherein the operations further comprise:
utilizing a generative adversarial network (GAN) to modify the classifying for optimal surface quality and productivity.

13. The computer system of claim 11, wherein the operations further comprise:
selecting a type of electrochemical machining required for each segment of the segments for electrochemical machining based on historical information of cutting and machining workpieces.

14. The computer system of claim 11, wherein the operations further comprise:
selecting a type of metal cutting required for each segment of the segments for metal cutting based on historical information of cutting and machining workpieces.

15. A computer program product comprising:
one or more computer-readable storage media; and
program instructions stored on the one or more computer-readable storage media to perform operations comprising:
generating a hybrid cutting-machining plan for a workpiece, including either metal cutting or electrochemical machining for segments of the workpiece, based on a design model analysis of areas of the workpiece requiring a high surface finish or having heat-sensitive zones;
determining a set of metal cutting parameters for each metal cutting operation in the hybrid cutting-machining plan;
determining a set of electrochemical machining parameters for each electrochemical machining operation in the hybrid cutting-machining plan;
integrating the metal cutting operations and the electrochemical machining operations into a manufacturing workflow, wherein the hybrid cutting-machining plan is optimized for optimal surface quality and productivity; and
outputting the manufacturing workflow.

16. The computer program product of claim 15, wherein the operations further comprise:
generating a graphical user interface that displays the hybrid cutting-machining plan and obtains modifications of the hybrid cutting-machining plan.

17. The computer program product of claim 15, wherein the operations further comprise:
selecting a type of cutting and a type of electrochemical machining for each segment of the segments based on the analysis.

18. The computer program product of claim 15, wherein the operations further comprise:
monitoring execution of the manufacturing workflow in real-time; and
adjusting a sequence of metal cutting and electrochemical machining operations, the set of metal cutting parameters, or the set of electrochemical machining parameters based on a surface quality threshold and productivity information.

19. The computer program product of claim 15, wherein the operations further comprise:
using historical data and machine learning algorithms to classify each segment of the segments of the workpiece as a metal cutting segment, an electrochemical machining segment, or both a metal cutting and electrochemical machining segment.

20. The computer program product of claim 15, wherein the operations further comprise:
simulating execution of the hybrid cutting-machining plan to predict potential errors or defects in the workpiece.
